(19) United States
(12) Patent Application Publication
(10) Pub. No.: US 2011/0007353 A1
(43) Pub. Date: Jan. 13, 2011

(54) IMAGE FORMING APPARATUS AND COMPUTER READABLE MEDIUM

(76) Inventors: Saori IURA, Tokyo (JP); Hiroya Uruta, Tokyo (JP); Masateru Kumagai, Kanagawa (JP); Naohiko Kubo, Kanagawa (JP); Daisuke Okada, Saitama (JP); Tetsuro Kutsuwada, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/831,555

(22) Filed: Jul. 7, 2010

(30) Foreign Application Priority Data
Jul. 9, 2009 (JP) 2009-162849
May 24, 2010 (JP) 2010-118445

(51) Int. Cl. G06F 3/12

(52) U.S. Cl. 358/1.15

(57) ABSTRACT

A disclosed image forming apparatus includes a filter detection part that detects the filter when the external medium is connected; a filter identification information obtaining part that obtains filter identification information that identifies a filter set by a user from filter setting information when print data subject to printing is received, wherein the filter setting information regarding the filter is added to the print data; a first output part that outputs the print data to the filter via the input/output interface, in accordance with the filter identification information; an input part that inputs the print data on which a predetermined process has been carried out by the filter via the input/output interface; and a second output part that outputs the print data on which the predetermined process has been carried out by the filter to a page description language module.

### BACKGROUND OF THE INVENTION

1. Field of the Invention

The present invention relates to an image forming apparatus that may use a filter that customizes data subject to processing and sets various processing conditions, and a computer-readable medium storing a computer program for use in the image forming apparatus.

2. Description of the Related Art

For example, Japanese Patent Application Laid-Open Publication No. 2005-284384, which is referred to as Patent Document hereinafter, discloses technology regarding the present invention. An invention disclosed in Patent Document includes an interface that transmits a data stream received by a print request reception server that is statically implemented as firmware to filter software (referred to as a filter) that enables dynamic loading and dynamic linkage, the filter being implemented in a built-in Java (registered trademark) environment. The filter is a computer program that enables functions for, for example, converting content of given data in accordance with a certain rule. With the above configuration, the invention of Patent Document can realize the following:

A static segment and a dynamic segment are clearly divided.

Inefficiency can be avoided in that all firmware is replaced with dynamic redundant software.

Inefficiency can be avoided in that a print request reception server function is duplicated and implemented also in a Java environment. A filter framework, which is legitimate in terms of apparatus costs and development efforts, can be realized.

In other words, the invention of Patent Document can realize the following:

Print data are converted to form a predetermined image, which is in turn output.

Processing after print data interpretation due to Page Description Language (PDL) such as print conditions including aggregation, bookbinding, both faces, and the like can be set.

Incidentally, a language used in each module is determined in the following manner in the invention of Patent Document.

Job control module of a printer: Native

Interpreter (interface with respect to a filter): OSGi, JAVA, JNI

Filter: interpreter language

For insertion and removal of the filter, an OSGi function is thought to be used. Therefore, there is a problem in that the filter cannot be configured by using a language other than the interpreter language.

The present invention has been made in view of the above, and is directed to an image forming apparatus that allows any filters to be used, and a computer-readable storage medium storing a computer program that causes the image forming apparatus to be able to use any filters.

### SUMMARY OF THE INVENTION

According to a first aspect of the present invention, there is provided an image forming apparatus in which a detachable external medium storing a filter is used, wherein the filter is an executable object and possesses an input/output interface pursuant to a predetermined specification. The image forming apparatus includes a filter detection part that detects the filter when the external medium is connected; a filter identification information obtaining part that obtains filter identification information that identifies the filter set by a user from filter setting information when print data subject to printing are received, wherein the filter setting information regarding the filter set by the user is added to the print data; a first output part that outputs the print data to the filter set by the user via the input/output interface, in accordance with the filter identification information; an input part that inputs the print data on which a predetermined process has been carried out by the filter set by the user, via the input/output interface; and a second output part that outputs the print data on which the predetermined process has been carried out by the filter set by the user, to a page description language module.

According to a second aspect of the present invention, there is provided a computer-readable medium that stores a program for use in an image forming apparatus in which a detachable external medium storing a filter is used, wherein the filter is an executable object and possesses an input/output interface pursuant to a predetermined specification. The program includes steps of detecting the filter when the external medium is connected; obtaining filter identification information that identifies the filter set by a user from filter setting information when print data subject to printing is received, wherein the filter setting information regarding the filter set by the user is added to the print data; outputting the print data to the filter set by the user via the input/output interface, in accordance with the filter identification information; inputting the print data on which a predetermined process has been carried out by the filter set by the user via the input/output interface; and outputting the print data on which the predetermined process has been carried out by the filter set by the user to a page description language module.

According to an embodiment of the present invention, there is provided an image forming apparatus that allows any filters to be used, and a computer-readable storage medium storing a computer program that causes the image forming apparatus to use any filters.

### BRIEF DESCRIPTION OF THE DRAWINGS

FIG. 1 is a block diagram illustrating a basic configuration of the image forming apparatus according to an embodiment of the present invention;

FIG. 2 illustrates an example of a component configuration in terms of software in the image forming apparatus according to an embodiment of the present invention;

FIG. 3 illustrates an example of a filter setting screen in the image forming apparatus according to an embodiment of the present invention;

FIG. 4 illustrates an example of Printer Job Language added to print data in the image forming apparatus according to an embodiment of the present invention;

FIG. 5 is a flowchart illustrating an operation of the image forming apparatus according to an embodiment of the present invention;

FIG. 6 is a flowchart illustrating an example of an operation in the image forming apparatus according to an embodiment of the present invention;

FIG. 7 illustrates an example of print data in the image forming apparatus according to an embodiment of the present invention;

FIG. 8 is a flowchart illustrating a process example of a filter function that converts a specific letter in print data into a color bold font in the image forming apparatus according to an embodiment of the present invention; and

FIG. 9 is a flowchart illustrating a process example of a filter function that changes a paper feed tray and a paper ejection destination per user in the image forming apparatus according to an embodiment of the present invention.

### DETAILED DESCRIPTION OF THE PREFERRED EMBODIMENTS

Referring to the accompanying drawings, preferred embodiments according to the present invention are explained. Before explaining an image forming apparatus according to the present invention, a printing process flow in a generic image forming apparatus (e.g., a printer) is explained in the following.

1) Print data (i.e., data subject to printing in a printer) is received by the printer, for example, through a network.

2) Printer Job Language (PJL) accompanying the received print data is interpreted, and a print condition of a requested job (print process) is recognized, in a job control module incorporated in the printer.

3) The print data are interpreted by a Page Description Language (PDL) module (i.e., a print data interpretation and drawing module).

4) The interpreted print data of an image are stored in a memory.

5) The image whose print data are stored in the memory is drawn (printed) on a medium such as paper.

In the image forming apparatus according to this embodiment, an object process of an executable format called a filter is carried out between the above steps 2) and 3). Specifically, an arbitrary number of filters can used and the filters used can be chosen per job. This embodiment is advantageous in that the arbitrary number of the filters that are detachable in the image forming apparatus are used to carry out print processes. Various processes can be carried out depending on the types of filters.

Specifications of the filters in this embodiment satisfy the following (1) and (2). Any filters complying with the following specifications can be used in this embodiment.

<Filter Specifications>

(1) A filter is an executable format object (if the filter is an executable object, any languages may be used.)

(2) A filter possesses an input/output I/F pursuant to an I/F determined by the job control module in the image forming apparatus.

Next, examples of what can be realized by the filters in a print process in the image forming apparatus according to this embodiment are explained. Specifically, the following two can be realized in this embodiment. First, the print data undergo a predetermined conversion stipulated in the filter and then are output. Second, processes (print conditions including aggregation, bookbinding, both faces, and the like) to be carried out, set before print data interpretation due to PDL, are re-set by the process stipulated in the filter and then output.

The print data undergo a predetermined conversion stipulated in the filter and then are output. Specifically, the print data undergo a predetermined conversion stipulated in the filter and are output in the following manner.

Attributes of specific letters or terms in the print data can be changed. More specifically, only a specific word in the print data may be changed to a bold face and/or a color letter. For example, a black fine letter string of “RICOH” may be converted to a red bold letter string.

Specific letters or terms can be replaced with different letters or terms. For example, the letter string of “RICOH” may be converted to a letter string of “Ricoh Company, Ltd.” Alternatively, a company-specific product code such as “ABC” may be converted to an actual product name such as “Imagio Neo xxxxxx”. In this case, additional care for, for example, editing an original document is not required when printing out the document.

A predetermined image and/or a letter string can be set (added) in a header and/or a footer of each page to be printed. For example, the letter string of “Ricoh Company, Ltd.” or a company logo of “RICOH” may be output in the header and/or the footer in each page.

In addition, processes (print conditions including aggregation, bookbinding, both faces, a paper feed tray, ejection destination and the like) before print data interpretations due to PDL are re-set by the process stipulated in the filter and output in the following manner.

The print data are printed out on both faces of paper or in a 2-in-1 aggregation layout. For example, when print data corresponding to eight pages are transmitted to the image forming apparatus, the data are automatically printed out on both faces of paper or in a 2-in-1 aggregation layout, and the printed sheets of paper are ejected. With this, users do not have to specify “both faces” or “2-in-1” on a driver.

A paper feed tray and a destination of ejected paper can be set for each user. For example, users whose names begin with letters A through N may use a paper feed tray 1 and main body ejection as a paper ejection tray, while users whose names begin with letters O through Z may use a bulk paper feed tray and a finisher upper tray as the paper ejection tray. In this case, a user A prints his or her own print data, using “paper feed tray: tray 1, destination of the ejected paper: main body ejection (paper ejection tray 1)”, and a user O prints his or her own print data, using “paper feed tray: bulk paper feed tray, destination of the ejected paper: finisher upper tray”.

Because the paper feed trays are assigned to users by the filter, a used amount of the paper stored in the paper feed tray can be known, and use of “@PJL SET HOSTPORTNAME” enables detailed monitoring of the amount of paper used. In addition, because the paper ejection trays are determined by the filter, the destination of the ejected paper can be changed per user, in order not to bring the image forming apparatus to a halt when a large amount of the ejected paper is output to a particular paper ejection tray. Incidentally, the paper feed tray used and the destination of the ejected paper may be changed per user along with “@PJL SET HOSTPORTNAME” obtained in association with “@PJL SET LOGINNAME”.

According to this embodiment, for example, “bolding of a specific letter string”, “printing a header and/or a footer”, “setting downstream processes such as including aggregation, bookbinding, both faces, and the like” or the like need not be manually carried out by the user, but can be automatically carried out by the filter, although such manual setting has been conventionally carried out by using a document editing application or a driver. Therefore, time and effort required to manually input by the user can be saved.

Next, an outline of the print process in the image forming apparatus according to this embodiment is explained.

1) First, it is assumed that the image forming apparatus (e.g., a printer) and an information processing apparatus (e.g., a personal computer (PC)) are connected to each other. In addition, the filter is stored in an external medium such as a Secure Digital (SD) memory card or a Universal Serial Bus (USB) memory. A user inserts the eternal medium into an external connection interface (external I/F) of the printer. A list of the filters stored in the external medium is displayed on a display of the printer.

2) The user chooses the filter to be used (a desired filter) from the displayed list. In this case, plural filters can be chosen.

3) The user carries out an operation for printing print data (e.g., document data) subject to the printing in, for example, a document application, in the PC. In this case, the chosen filter is displayed on a PC display due to bidirectional communications between the printer and the PC. Alternatively, a list of the filters and a re-chosen filter may be displayed on the PC display. In addition, when a printer driver, which may be referred to simply as a driver, receives a request for the print process from an Operating System (OS), the driver adds (or appends) a program name or the like of the chosen filter as a print data print condition (PJL) to the print data, and transmits the print data to the printer.

4) When the printer receives the print data, the printer interprets the added PJL and obtains a path name (information that specifies the filter) of a path where the filter exists, from the program name of the interpreted filter.

5) The print data are sent to the filter in accordance with the obtained path name.

6) The filter carries out a predetermined process with respect to the received print data. When plural filters are chosen, the print data are sent from the filter whose process is completed to the next filter. Namely, the print data are sent in turn from filter to filter among the chosen filters.

7) The print data are sent to the PDL, and interpreted. Then, the interpreted print data of an image are stored in a memory (storage device and/or storage medium).

8) The image of the print data stored in the memory is drawn on a medium such as a sheet of paper.

Such a series of procedures is described in detail later.

While the outline of the image forming apparatus according to this embodiment has been completed here, a specific configuration and an operation of the image forming apparatus according to this embodiment are explained in the following.

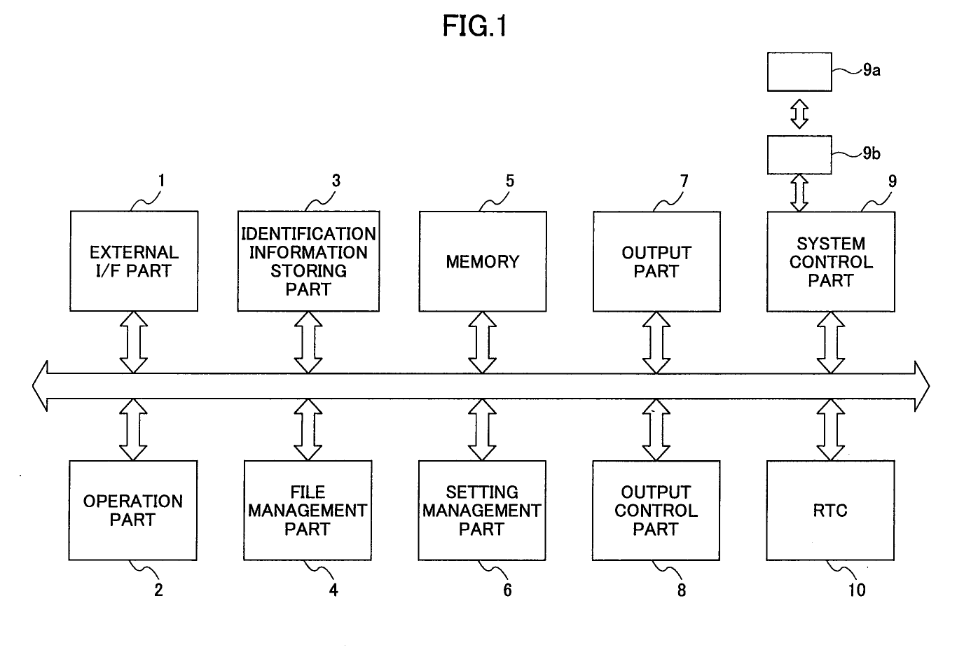

FIG. 1 is a block diagram illustrating a basic configuration of the image forming apparatus according to this embodiment of the present invention. As shown, the image forming apparatus according to this embodiment includes an external I/F part 1 that communicates with an external apparatus such as the PC, and the external medium such as the SD card or the USB memory; an operation part (operation/display part) with which the user can set various functions of the image forming apparatus and on which information on or status of the image forming apparatus is displayed for the user; an identification information storing part 3 that stores identification information sent from a sender; a file management part 4 that carries out file management/control of the identification information; a memory 5 that extracts and stores image data or the like; a setting management part 6 that manages or controls the set functions; an output part 7 that outputs/prints an image on a sheet of paper in accordance with a series of the procedures; an output control part 8 that processes and controls the received image data so that the output part 7 can form the image; a system control part 9 that controls the entire image forming apparatus; and a real time clock 10 having clock and/or calendar functions.

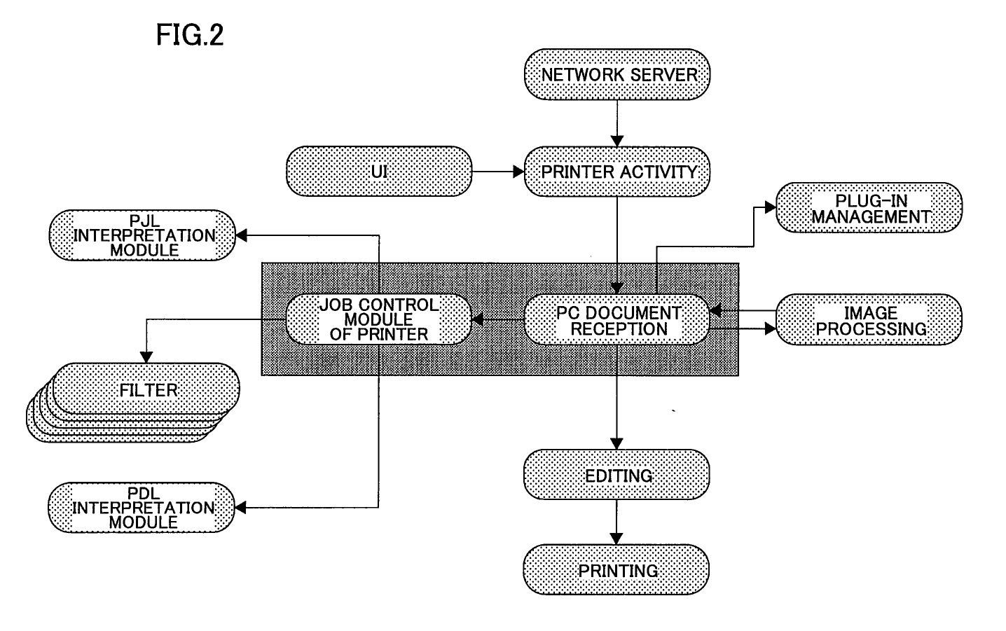

FIG. 2 illustrates an example of a component configuration from an aspect of software in the image forming apparatus according to this embodiment. In FIG. 2, oval frames indicate component units. Printer activity corresponds to an activity component. PC document reception, editing, and printing constitute filter components. Messages are exchanged between the activity and filters. Images are transmitted and received between the filters. A flow of the image data is from left to right in the drawing. The activity carries out job management. The printer activity carries out print job management. The PC document reception analyses the print data received from the PC (an example of the external apparatus) via the network, and carries out image processing. A job control module of the printer is one of modules in the PC document reception, and carries out printing (print process) job control. A PJL interpretation module interprets job control language included in the print data. A PDL interpretation module interprets an interpretation language included in the print data, and modifies the image print data. Each filter carries out a predetermined process with respect to the print data. Image processing carries out a process that transmits the image print data in the memory management or the memory to an engine. Plug-in management manages installing, uninstalling, updating, or the like. Editing carries out rotation and/or combining of the images to be printed. Printing prints the image on a plotter.

Incidentally, the printer activity in FIG. 2 corresponds to the system control part 9 in FIG. 1; the image processing in FIG. 2 corresponds to a combination of the memory 5 and the output control part 8 in FIG. 1; the plug-in management in FIG. 2 corresponds to a combination of the external I/F part 1 and the system control part 8 in FIG. 1; the filter in FIG. 2 corresponds to the external I/F part 1; the PC document reception in FIG. 2 corresponds to a combination of the output control part 9 and the setting management part 6 in FIG. 1; the editing in FIG. 2 corresponds to the output control part 8; and the printing in FIG. 2 corresponds to the output control part 8 in FIG. 1.

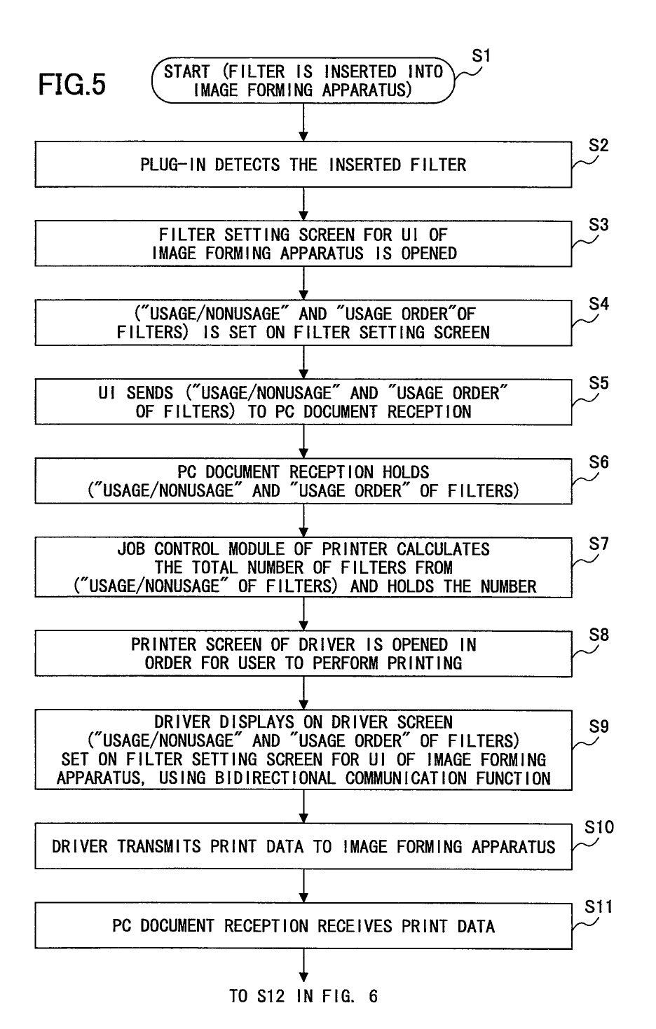

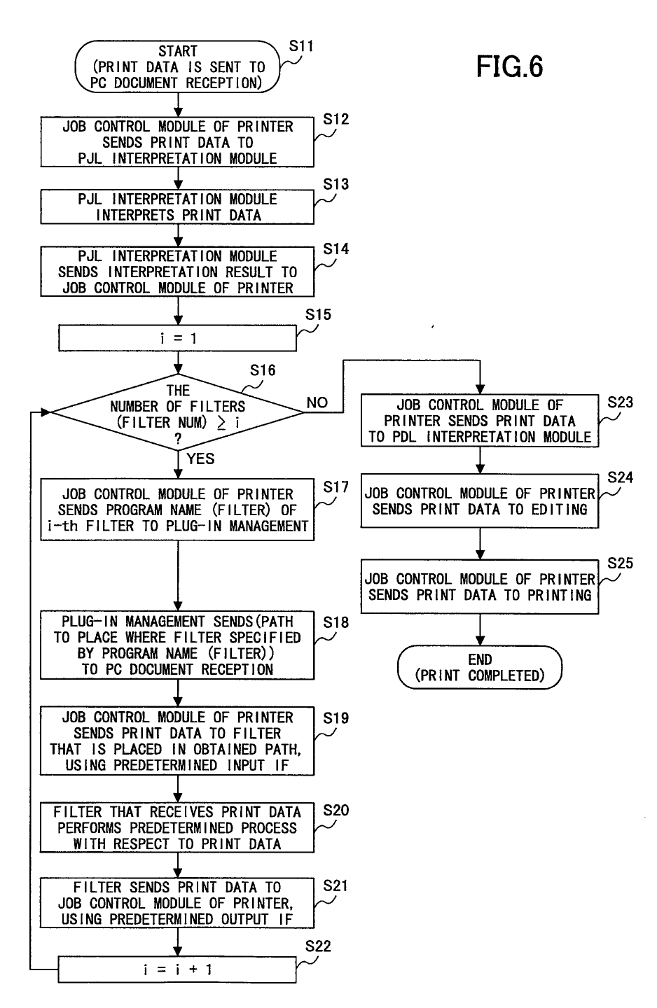

An example of an operation of the image forming apparatus configured above according to this embodiment is explained with reference to FIGS. 5 and 6, which are flowcharts illustrating an example of the operation of the image forming apparatus according to this embodiment.

When a user connects the external medium to the image forming apparatus (S1), the plug-in management detects filters stored in the external medium (S2). The filters satisfy the following specification (1) and (2).

(1) A filter is an executable format object (if the filter is an executable object, any language may be used.)

(2) A filter possesses an input/output I/F pursuant to an I/F determined by the job control module in the image forming apparatus.

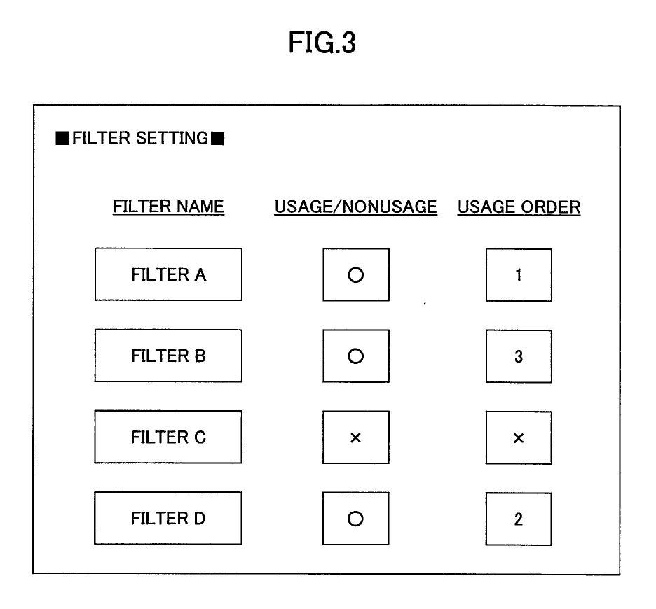

In the UI (User Interface, which corresponds to the operation part 2 in FIG. 1) of the image forming apparatus, a filter setting screen is opened (S3). This filter setting screen displays a list of the filters stored in the external medium. An example of the displayed list is shown in FIG. 3. As shown, the user can set usage/nonusage of each filter, and usage order, when necessary, although this example does not limit the filters usable in the image forming apparatus.

The user sets the usage/nonusage of the filters and the usage order in the filter setting screen (S4).

After the setting is completed, the UI of the image forming apparatus sends the usage/nonusage of the filters and the usage order (filter setting information) to the PC document reception via the printer activity (S5).

The PC document reception receives and holds the usage/nonusage information of the filters and the usage order (S6).

The job control module of the printer calculates the total number of the filters (FILTER_NUM) from the usage/nonusage information of the filters, and holds the total number (S7). The program names of the corresponding filters are held as variables in accordance with the total number of the filters and the usage order in the following manner, for example:
FILTER6=a program name of the filter used in the i-th order
FILTER_NUM=the total number of the filters used.

The user opens a print screen of the driver in the information processing apparatus such as the PC in order to carry out printing in the image forming apparatus according to this embodiment (S8). The information processing apparatus is connected to the image forming apparatus according to this embodiment, and can carry out data communications.

The driver uses the bidirectional communication function and displays the usage/nonunsage information of the filters and the usage order set in the filter setting screen on a driver screen (S9). This screen maybe the same screen as that shown in FIG. 3, for example, or an arranged screen that displays the same content as that of FIG. 3 in a different display layout. The user confirms the usage/nonusage of the filters and the usage order that have been set, from the displayed screen. Incidentally, the user may change or re-set the contents that have been set, in this screen.

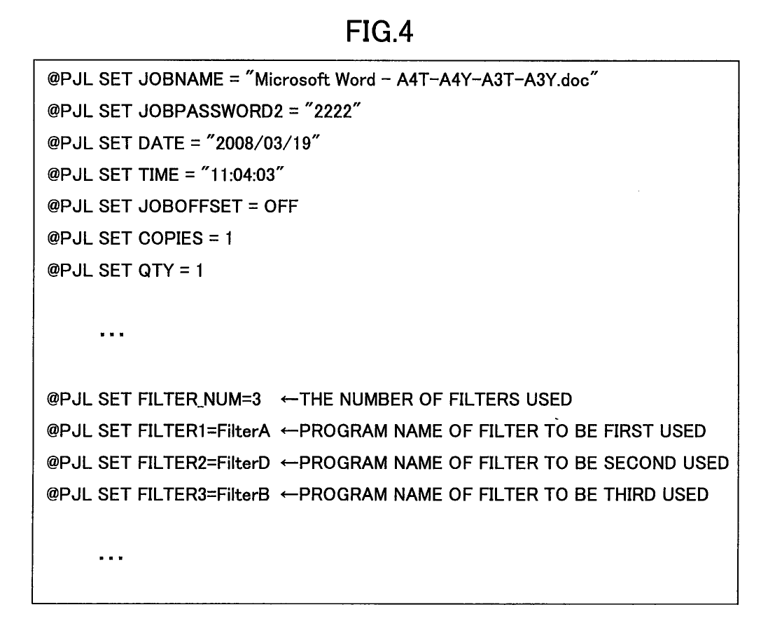

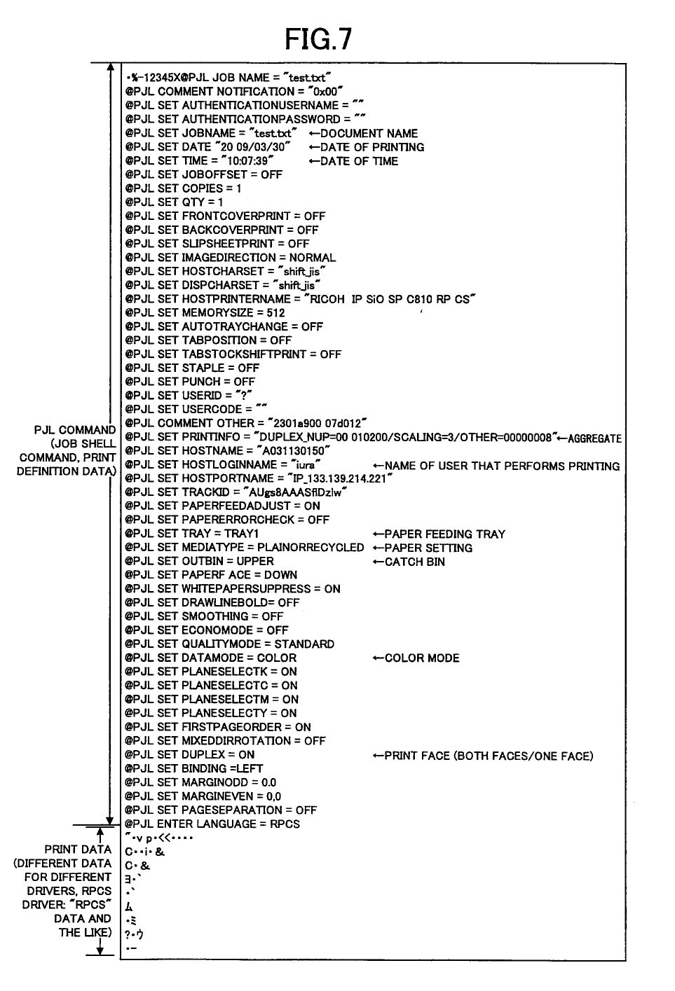

The user carries out an operation for specifying desired print data from, for example, a document creating/editing application. In this case, the driver adds the print condition (PJL), namely, the usage/nonusage of the filters and the usage order (filter setting information) to the specified print data, and transmits the print data to the image forming apparatus (S10). An example of the PJL added to the print data is shown in FIG. 4. As shown, the number of the set filters (usage/nonusage) is added to the specified print data, and the program names of the corresponding filters are added in the usage order. In addition to the PJL commands shown in FIG. 4, other PJL commands shown in FIG. 7, for example, may be added.

The PC document reception receives the print data to which the PJL is added (S11).

The job control module of the printer (image forming apparatus) sends the image data to the PJL interpretation module (S12).

The PJL interpretation module interprets the print data (S13).

The PJL interpretation module sends a PJL interpretation result to the job control module of the printer (S14).

As a result of the interpretation, when the number of the chosen filters (FILTER_NUM) is greater than 1 (S15-S16: YES), the job control module of the printer sends a program name (FILTER) of a first filter to the plug-in management (S17).

The plug-in management sends a “path to a place where the filter specified by the program name (FILTER) is placed” to the PC document reception (S18). The “path” here is, for example but not limited to, information that can identify the filter (filter identification information).

The job control module of the printer sends the print data to the filter that is placed in the obtained path, using a predetermined input IF (S19).

The filter that receives the print data carries out a predetermined process with respect to the print data (S20).

The filter sends the print data to the job control module of the printer, using a predetermined output IF (S21).

When there remains the filter(s) set (or chosen) by the user, a second or the following filters carry out the above steps S17 through S22 (S22-S16: YES).

When there remains no filter set (or chosen) by the user (S16: NO), the job control module of the printer sends the print data that have undergone process(es) carried out by the filter(s) to the PDL interpretation module (S23). After the PDL interpretation is completed, the PDL interpretation module sends the print data that have undergone the PDL interpretation to the job control module of the printer.

The job control module of the printer sends the print data to the editing (S24).

The job control module of the printer sends the print data to the printing (S25). With this, the print procedures are completed.

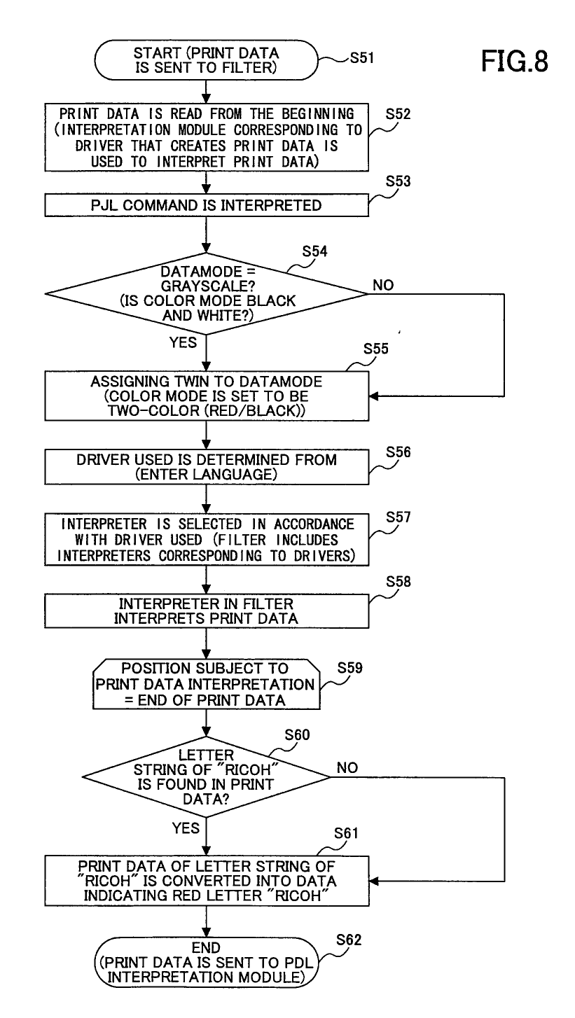

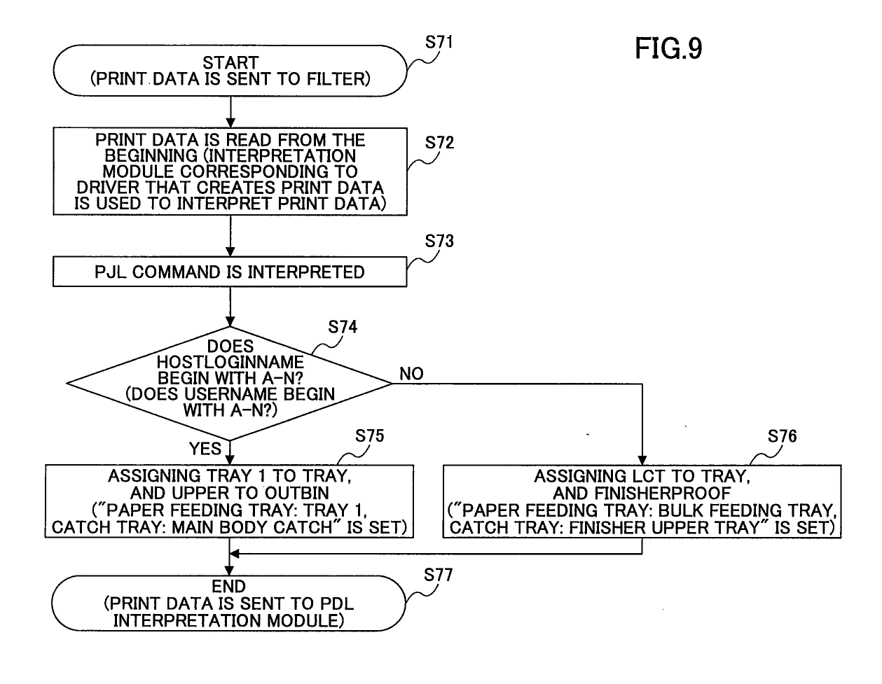

Next, an example of the process carried out in the filter that receives the print data is explained with reference to FIGS. 8 and 9. However, before explaining the process, an example of the print data created and output by the driver is shown in FIG. 7. As shown, the print data of this embodiment has, for example, a format including the PDL commands.

FIG. 8 is a flowchart illustrating an example of a function of the filter, specifically, a function of converting specific letters or terms in the print data into a bold face and a color letter. Here, a letter string of “RICOH” specified to be printed in a black fine face in the print data is converted into a letter string of red bold face.

When the filter receives the print data (S51), the print data are read from the beginning (S52), and the PLJ command is interpreted (S53). Incidentally, the print data interpretation is carried out using the interpretation module corresponding to that driver that creates print data.

Next, it is determined whether a data mode is a gray scale, namely, a color mode or a black-and-white mode (S54). The letter string of “RICOH” is determined to be printed in one of two colors (red, black), and the color mode is set to be two colors (red, black) (S55).

Next, the driver being used is determined based on “ENTER LANGUAGE” (S56).

Next, a printer in the filter is chosen in accordance with the driver being used (S57). In the filter, there are interpreters corresponding to the drivers.

Next, the interpreter in the filter interprets the print data while extracting the letter string to be converted into the red bold face, which is the letter string of “RICOH” in the black fine face, in this case (S58).

Then, when the print data interpretation reaches the end of the print data (S59) and the letter string of “RICOH” in the black fine face is found (S60), the letter string is converted into the “RICOH” in the red bold face (S61).

Finally, the print data are sent to the PDL interpretation module (S62). In such a manner, when the color and the width of the letter string are set in the filter, the letter string is printed in the specified color and width after having been automatically converted. Therefore, care for editing the original document is not required at the time of printing out the document.

Next, another example of an operation is explained with reference to FIG. 9, which is a flowchart illustrating an example of a function of the filter, specifically, a function of specifying a paper feed tray used and a destination of the ejected paper. As an example, when a user name begins with A through N, the user uses a paper feed tray 1 and main body ejection as a paper ejection tray, while for a user name that begins with O through Z, the user uses a bulk paper feed tray and a finisher upper tray as the paper ejection tray.

When the print data are sent to the filter (S71), the print data are read from the beginning (S72), and the PJL command is interpreted (S73). Incidentally, the print data interpretation is carried out using the interpretation module corresponding to the driver that creates print data.

Next, it is determined whether a hostloginname, namely, a user name, begins with A through N (S74).

When the user name begins with A through N (S74: YES), the paper feed tray is set to be a tray 1, and the paper ejection tray is set to be the main body ejection. On the other hand, when the user name begins with O through Z (S74: NO), the paper feed tray is set to be a bulk paper feed tray, and the paper ejection tray is set to be a finisher upper tray (S76).

Finally, the print data are sent to the PDL interpretation module (S77).

As explained above, when the filters are used that can convert the print data into a predetermined image to output the converted image, and set the processes (print conditions including aggregation, bookbinding, both faces and the like) after the PDL interpretation of the print data, any filters that satisfy the following specification (1) and (2) can be used according to this embodiment.

<Filter Specifications>

(1) A filter is an executable format object (if the filter is an executable object, any languages may be used.)

(2) A filter possesses an input/output I/F pursuant to an I/F determined by the job control module in the image forming apparatus.

While the present invention has been explained with reference to several embodiments, the present invention is not limited to the foregoing embodiments, but various modifications may be made without departing from the scope of the present invention.

For example, the operations in the above embodiments may be realized by hardware, software, or a combination of hardware and software.

When the operations are realized by the software, a program where a process sequence is recorded may be installed into the system control part 9 (FIG. 1) or other exclusively provided hardware, and executed by the hardware. Alternatively such a program may be installed into a generic information processing computer that enables various processes, and executed by the computer.

The program may be temporarily or permanently stored in a computer-readable medium 9a and installed into the system control part 9 via an input/output (I/O) device 9b (see FIG. 1). The computer-readable medium 9a may be a hard disk (HD), or a Read Only Memory (ROM). Alternatively, the computer-readable medium 9a may be a removable storage medium such as a Compact Disk Read Only Memory (CD-ROM), a Magneto Optical (MO) disk, a Digital Versatile Disk (DVD), a magnetic disk, a semiconductor memory or the like. Such a removable storage medium may be provided as so-called package software.

Incidentally, the program may be installed through radio communication from a download site, rather than the removable storage medium. Alternatively, the program may be installed through a network such as a Local Area Network (LAN) or the Internet. In such a case, the program may be downloaded into a built-in storage medium such as a hard disk.

The operations explained above may be carried out not only in chronological order but also in a parallel manner or separately, when necessary, depending on performance of the image forming apparatus.

In addition, the system explained above may be collectively composed of plural apparatuses, or composed of mixed functions of plural apparatuses.

The present invention is applicable to an apparatus/appliance, a system, a method, a program, and the like that use a filter to carry out image processing.

The present application is based on Japanese priority applications No. 2009-162849 and 2010-118445 filed on Jul. 9, 2009 and May 24, 2010, respectively, with the Japanese Patent Office, the entire contents of which are hereby incorporated by reference.

What is claimed is:

1. An image forming apparatus in which a detachable non-transitory external medium storing a filter and readable by the image forming apparatus is used, wherein the filter is an executable object and possesses an input/output interface pursuant to a predetermined specification, the image forming apparatus comprising:
a filter detection part that detects the filter when the external medium is connected;
a filter identification information obtaining part that obtains filter identification information that identifies the filter set by a user from filter setting information when print data subject to printing is received, wherein the filter setting information regarding the filter set by the user is added to the print data;
a first output part that outputs the print data to the filter set by the user via the input/output interface, in accordance with the filter identification information;
an input part that inputs the print data on which a predetermined process has been carried out by the filter set by the user, via the input/output interface; and
a second output part that outputs the print data on which the predetermined process has been carried out by the filter set by the user, to a page description language module.

2. The image forming apparatus of claim 1, wherein the filter setting information includes a program name of the filter set by the user,
wherein when the user selects plural of the filters the filter setting information includes an order of the program names corresponding to the filters in accordance with an order of the filters to be used.

3. The image forming apparatus of claim 1, wherein the filter setting information is set in at least one of a user interface of the image forming apparatus and another user interface of an information processing apparatus that is capable of communicating with the image forming apparatus.

4. The image forming apparatus of claim 1, further comprising a bidirectional communication part that communicates with an information processing apparatus that is capable of communicating with the image forming apparatus, wherein a program name of the filter stored in the external medium is transmitted by the bidirectional communication part to the information process apparatus, and is displayed on a user interface of the information process apparatus.

5. The image forming apparatus of claim 1, wherein the filter setting information is added to the print data using a print job language.

6. The image forming apparatus of claim 1, wherein a letter attribute of a letter included in the print data is changed as the predetermined process.

7. The image forming apparatus of claim 1, wherein a letter included in the print data is converted to a different letter as the predetermined process.

8. The image forming apparatus of claim 1, wherein the filter setting information includes a print condition set by the user,
wherein a paper feed tray and/or a paper ejection destination included in the print condition are changed per user as the predetermined process.

9. A computer-readable non-transitory medium that stores a program for use in an image forming apparatus in which a detachable non-transitory external medium storing a filter and readable by the image forming apparatus is used, wherein the filter is an executable object and possesses an input/output interface pursuant to a predetermined specification, the program comprising steps of:
detecting the filter when the external medium is connected;
obtaining filter identification information that identifies the filter set by a user from filter setting information when print data subject to printing is received, wherein the filter setting information regarding the filter set by the user is added to the print data;
outputting the print data to the filter set by the user via the input/output interface, in accordance with the filter identification information;
inputting the print data on which a predetermined process has been carried out by the filter set by the user via the input/output interface; and
outputting the print data on which the predetermined process has been carried out by the filter set by the user to a page description language module.

10. The computer-readable non-transitory medium of claim 9, wherein the filter setting information includes a program name of the filter set by the user, and
wherein when the user selects plural of the filters the filter setting information includes an order of the program names corresponding to the filters in accordance with an order of the filters to be used.

11. The computer-readable non-transitory medium of claim 9, wherein the filter setting information is set in at least one of a user interface of the image forming apparatus and another user interface of an information processing apparatus that is capable of communicating with the image forming apparatus.

12. The computer-readable non-transitory medium of claim 9, further comprising a bidirectional communication part that communicates with an information processing apparatus that is capable of communicating with the image forming apparatus, wherein a program name of the filter stored in the external medium is transmitted by the bidirectional communication part to the information process apparatus, and is displayed on a user interface of the information process apparatus.

13. The computer-readable non-transitory medium of claim 9, wherein the filter setting information is added to the print data using a print job language.

14. The computer-readable non-transitory medium of claim 9, wherein a letter attribute of a letter included in the print data is changed as the predetermined process.

15. The computer-readable non-transitory of claim 9, wherein a letter included in the print data is converted to a different letter as the predetermined process.

16. The computer-readable non-transitory medium of claim 9, wherein the filter setting information includes a print condition set by the user,
wherein a paper feed tray and/or a paper ejection destination included in the print condition are changed per user as the predetermined process.
